(19) United States
(12) Patent Application Publication
(10) Pub. No.: US 2015/0381025 A1
(43) Pub. Date: Dec. 31, 2015

(54) LAES OPERATING PHASE CHANGE MATERIALS

(71) Applicant: MADA Energie LLC, New York, NY (US)

(72) Inventors: ARNOLD J. GOLDMAN, JERUSALEM (IL); Elazar Avraham GOLDMAN, JERUSALEM (IL)

(21) Appl. No.: 14/751,094

(22) Filed: Jun. 25, 2015

Related U.S. Application Data
(60) Provisional application No. 62/017,236, filed on Jun. 25, 2014.

(51) Int. Cl. H02K 55/00; H01B 12/16; H02K 9/20; F01D 15/10; H02K 7/18

(52) U.S. Cl. CPC H02K 55/00; F01D 15/10; H02K 7/1823; H02K 9/20; H01B 12/16; F25D 3/10

(57) ABSTRACT

In one or more embodiments, a Liquid Air Energy Storage apparatus comprises one or more motors, one or more generators, one or more transformers, and a liquid air storage unit. The one or more motors can be adapted to compress a working fluid. The one or more generators can be adapted to produce electric energy. The one or more transformers can be adapted to convert electric energy. At least one of the motors, the generators, and the transformers can comprise a superconductive material.

### CROSS-REFERENCE TO RELATED APPLICATIONS

The present application claims the benefit of U.S. Provisional Application No. 62/017,236, filed Jun. 25, 2014, which is hereby incorporated by reference herein in its entirety.

### FIELD AND BACKGROUND

Embodiments of the present invention relate generally to the field of energy. More specifically, embodiments relate to the usage of superconducting electrical machines as specific devices within a Liquid Air Energy Storage (LAES) system.

There may be many different reasons for the desire for energy storage (and/or fixable energy generation and dispatchment). One such reason may be the addition of electrical capacity generated by renewable sources. Although there may be many reasons for the desire for energy storage, the renewable sources being introduced to the grid are at many times one reason for the storage desire.

### SUMMARY

In one or more embodiments, a Liquid Air Energy Storage apparatus comprises one or more motors, one or more generators, one or more transformers, and a liquid air storage unit. The one or more motors can be adapted to compress a working fluid. The one or more generators can be adapted to produce electric energy. The one or more transformers can be adapted to convert electric energy. At least one of the motors, the generators, and the transformers can comprise a superconductive material.

In one or more embodiments, a Liquid Air Energy Storage apparatus comprises one or more motors, one or more generators, one or more transformers, a liquid air storage unit, and a solar photovoltaic electrical energy production facility. The one or more motors can be adapted to compress a working fluid. The one or more generators can be adapted to produce electric energy. The one or more transformers can be adapted to convert electric energy. At least one of the motors, the generators, the transformers, and the solar photovoltaic electrical energy production facility can comprise a superconductive material.

In one or more embodiments, a facility comprises at least three apparatuses. At least one apparatus is a LAES, at least one apparatus is one of an Air Separation Unit (ASU) and/or an Air Liquefaction Unit (ALU), and at least one apparatus is one of a coal power plant and/or a gas turbine and/or a PV filed and/or a wind turbine. At least one component of the at least one apparatus of a coal power plant and/or a gas turbine and/or a PV filed and/or a wind turbine can be a superconductor. The superconductor component can reach a state of superconductivity achieved by passing at least one of liquid air and/or liquid air components and/or desired temperature air in a gas form and/or air components in a gas form, thus achieving desired low temperature of the superconductor component. The at least one of liquid air and/or liquid air components and/or desires temperature air in a gas form and/or air components in a gas form can be generated by at least one of the LAES and/or ASU and/or ALU.

In one or more embodiments, a Liquid Air Energy Storage apparatus comprises first components and a liquid air storage unit. The first components can include a motor adapted to compress a working fluid, a generator adapted to produce electric energy, and a transformer adapted to convert electric energy. At least one of the first components can comprise a superconductive material.

In one or more embodiments, a system comprises a first unit, a second unit, a third unit, and a controller. The first unit can be a Liquid Air Energy Storage unit (LAES). The second unit can be an Air Separation Unit (ASU) or an Air Liquefaction Unit (ALU). The third unit can be a coal power plant, a gas turbine, a PV field, or a wind turbine. The third unit can comprise at least one component that is a superconductor. The controller can configure the system to cool the superconductor component to a desired low temperature such that a state of superconductivity is reachable by the superconductor component. The cooling the superconductor component can include passing material generated by the first and/or second units to the third unit to achieve the desired low temperature of the superconductor component. The material can be at least one of liquid air, liquid air components, desired temperature air in a gas form, and/or air components in a gas form.

In one or more embodiments, a method for cooling superconductive components of an energy system includes providing a system comprising a first unit, a second unit, a third unit, and a controller. The first unit can be a Liquid Air Energy Storage unit (LAES). The second unit can be an Air Separation Unit (ASU) or an Air Liquefaction Unit (ALU). The third unit can be a coal power plant, a gas turbine, a PV field, or a wind turbine. The third unit can comprise at least one component that is a superconductor. The method can include cooling the superconductor component to a desired low temperature such that a state of superconductivity is reachable by the superconductor component, the cooling comprising passing material generated by the first and/or second units to the third unit to achieve the desired low temperature of the superconductor component. The material can be at least one of liquid air, liquid air components, desired temperature air in a gas form, and/or air components in a gas form.

Objects and advantages of embodiments of the disclosed subject matter will become apparent from the following description when considered in conjunction with the accompanying drawings.

### BRIEF DESCRIPTION OF THE DRAWINGS

Embodiments will hereinafter be described with reference to the accompanying drawings, which have not necessarily been drawn to scale. Where applicable, some features may not be illustrated to assist in the illustration and description of underlying features. Throughout the figures, like reference numerals denote like elements. Any values illustrated in the accompanying graphs and figures are for illustration purposes only and may not represent actual or preferred values. Where applicable, some features may not be illustrated to assist in the description of underlying features. As used herein, various embodiments can mean one, some, or all embodiments.

FIG. 1 illustrates a Liquid Air Energy Storage (LAES) apparatus with superconducting devices, such as a motor and a generator, in accordance with an embodiment.

FIG. 2 illustrates a Liquid Air Energy Storage (LAES) apparatus with superconducting devices, such as a motor and a generator, in conjunction with a superconducting PV facility, in accordance with an embodiment.

FIG. 3 illustrates a LAES apparatus operating alongside an Air Liquefaction Unit (ALU) and/or an Air Separation Unit (ASU), in accordance with an embodiment.

FIG. 4 illustrates a LAES apparatus operating alongside an Air Liquefaction Unit (ALU) and/or an Air Separation Unit (ASU), in conjunction with a coal power plant and/or gas turbine, in accordance with an embodiment.

FIG. 5 Illustrates a LAES apparatus operating alongside an Air Liquefaction Unit (ALU) and/or an Air Separation Unit (ASU), in conjunction with one or more wind turbine/s, in accordance with an embodiment.

### DETAILED DESCRIPTION

Efficiency may play an important role in the field of energy storage. Facilities that store energy many times operate in at least two modes of operation. Whereas one mode of operation may be charging and the other may be discharging. Energy storage and more specifically electrical energy storage facilities or apparatuses may draw down electrical energy from the electrical grid (or other electrical source) during one period of time, and may dispatch electrical energy to the electrical grid (or other consumer) during a second period of time. Different storage technology may store the energy differently based on the specific application such as Pumped Storage Hydro (PSH), Compressed Air Energy Storage (CAES), batteries, Liquid Air Energy Storage (LAES) etc. Due to the two-cycle nature of storage (charge/discharge) the round trip efficiency of the different technologies may play a leading role.

One embodiment of the disclosed matter reveals the operation of some superconducting electrical machines and/or devices in a LAES apparatus. Superconducting electrical machines or devices may have different advantages. Whereas one such advantage may be higher efficiency. Devices such as motors, generators and others may suffer less loss (electrical loss) than non-superconducting electrical motors, generators, transformers and others. The reduction in the loss may be achieved due to a reduction in the current loss with superconducting wire in relation to copper wires and/or other wires. However achieving the state of superconductivity in the wires may be a challenge, due to the process of significantly cooling down the wires. Efforts are undergoing to increase the target temperature to reach the state of superconductivity in such means as wires. However, as of today, many of the superconductors require significant temperature reduction. In different applications such as energy conservation, electrical energy generation, etc. the use of superconducting machines or devices may be an advantage. However, in many applications the difficulty in temperature reduction outweighs the benefit gained by the superconductors. Reduction in the temperature may require a cooling device, refrigeration, cryogen or any other cold source.

By one embodiment of the disclosed matter, a LAES is revealed that includes superconducting electrical machines. LAES, as will be detailed below, is an energy storage apparatus that operates in two main modes of operation: charging and discharging (or standby when neither mode is taking place). During the charging mode electrical energy is converted to thermal energy which is stored in the LAES for later use. Thermal energy generated by the LAES is in the form of high temperature and low temperature thermal energy. Generating and storing high temperature thermal energy is achieved by trapping and compressing ambient air (air stream). As a result of the compression, the air stream's temperature increases, the high temperature is extracted from the air stream via direct and/or non-direct heat exchange, and stored in a suitable heat media contained in a suitable heat storage vassal, known to one who is familiar in the art of thermal storage. Low thermal energy temperature generated and stored in the LAES is achieved by extracting high temperature from the air stream, cooling down and expanding the air stream, to achieve phase change of the air stream to liquid air that is stored in a liquid air vessel known to one who is familiar in the art of cryogen. The generation of thermal energy at both high and low (cryogen) temperatures occurs during the charging cycle of the LAES. The low temperature of the liquid air may be sufficient to reduce the temperature of the superconducting wires to reach a phase change to a state of superconductivity, if applied to the wires.

By one embodiment of the disclosed matter, a LAES apparatus is revealed that includes one or more superconductive devices. Whereas during the charging cycle of the LAES an air stream trapped and compressed from the environment is processed and liquefied. Processing the air stream may involve compression, heat extraction, purification, expansion etc. which may result in a phase change of the air stream to a liquid air which may be stored. In some embodiments, a portion of the liquid air that has been generated may be directed to different superconducting devices within the apparatus, in order to achieve a phase change to the state of superconductivity. Some of the devices may be a motor (one or more), a generator (one or more), or a transformer (one or more).

In some embodiments, liquid air is directed to the motors in order to reach a phase change to the state of superconductivity. In such a case, the motors may be configured with preselected superconducting wires. These wires may achieve a phase change to the state of superconductivity upon (or shortly after) contact (direct or other) with the liquid air. The motors operating in the state of superconductivity may realize a gain in efficiency due to the reduction in losses which occur in standard copper wires of motors.

In some embodiments, liquid air is directed to the generators in order to reach change phase to the state of superconductivity. In such a case, the generators may be configured with preselected superconducting wires. These wires may achieve a phase change to the state of superconductivity upon (or shortly thereafter) contact (direct or other) with the liquid air and or other suitable refrigeration means (such as liquid air components, or gas at a suitable temperature). The generator/s operating in the state of superconductivity may realize a gain in efficiency due to the reduction in losses which occur in standard copper wires from generators and an increase in current density.

Another device that suffers from loss can be one or more transformers of the LAES (and/or other power plants such as coal power plant, gas turbines, wind turbines, nuclear power plants etc.). The one or more transformers can be and/or have at least one device of the transformer may be of a superconductive material. Whereas the state of superconductivity is achieved in a similar method as that the wires of the generators, that is the transformers may achieve a phase change to the state of superconductivity upon (or shortly thereafter) contact (direct or other) with the liquid air and or other suitable refrigeration means (such as liquid air components, or gas at a suitable temperature)

In some embodiments, directing the liquid air to the motors, generators, transformers etc. may occur during different periods of time or more specifically different modes of operation. During the charging cycle liquid air may be directed to the motors and during the discharge cycle liquid air may be directed to the generators and transformers, in some embodiments. The liquid air that was directed toward the wires may not suffer a phase change, and in such a case the liquid air may be directed back to the liquid air storage vessel. However, the liquid air directed to the wires may undergo a phase change, and in such a case the air stream may be directed back into the LAES system. Additionally or alternatively, the low temperature of the air stream may be extracted from the air stream and stored in a thermal energy storage tank, to be used at a later period of time during one or more processes of either the charging or discharging cycle.

In some embodiments, cooling down the different superconducting devices to reach a phase change to the state of superconductivity may be achieved by utilizing different sources for different devices, or more specifically, different sources for different devices that are operating during different modes of operation. During the charging cycle, a portion of the air stream may undergo a phase change and achieve a liquefaction state. Whereas a second portion of the air stream will not undergo a phase change and remains in a gas state. The portion of the air stream that has not become a liquid may be referred to as a byproduct air stream (byproduct). In some embodiments, during the charging cycle the byproduct air stream (or a portion of the stream) may be directed to the superconducting devices operating in the charging cycle, such as the motor/s, in order to cool down the superconductors within the device to reach a phase change to the state of superconductivity. In some embodiments, the byproduct used to generate a phase change to the state of superconductivity may be redirected back to the charging cycle of the LAES in order to cool down the air stream entering the LAES.

An energy storage apparatus such as a LAES which generates a cryogen such as liquid air may have the benefit of operating superconducting devices with little additional capital cost, due to the generation of a cryogen in at least one mode of operation. Thus, there is no additional need and/or limited need for additional cooling devices or cooling substances to be added to the apparatus, for the purpose of operating superconducting devices.

Maintaining the state of superconductivity may require a lesser amount of energy than reaching a phase change to the state of superconductivity. Although insulation for the superconducting devices may be desired, there may be a relatively low heat transfer rate from the devices to the surroundings. In some embodiments, a control system is used to determine and/or control the flow rate of the cryogen to the devices at different states of superconductivity. In some embodiments, the control system can comprise a processor and memory.

In some specific grid regions the desired operations of the LAES may contain rapid shifts from charge to discharge, and such shifts in operation may result in an efficiency loss of the system in some embodiments. The use of electric machines in some embodiments with the state superconductivity may decrease the efficiency loss due to rapid shifts from charge to discharge, thus increasing the overall efficiency of the facility.

By one or more embodiments of the disclosed matter a LAES apparatus in conjunction with an Air Liquefaction Unit (ALU) and/or Air Separation Unit (ASU) is revealed. It may be desirable for the LAES to receive an external cold input. A cold input could be understood as a cold input to the LAES whereas the cold is generated in one such a process that does not require the utilization of the LAES's cold storage during the generation period of the cold input. The ALU and/or ASU may generate liquid air or liquid air components. The generated liquid air and/or liquid air components can be transferred to one or more destinations including the liquid air tank of the LAES. The liquid air and/or liquid air components which has been generated by the external ALU and/or ASU may be utilized by the LAES during the discharge cycle.

By one embodiment of the disclosed subject matter, a LAES apparatus in conjunction with a photovoltaic (PV) facility is disclosed in which some of the PV's cell components are of superconducting materials. These parts may be wires, superconducting films, semiconductors, and/or other components that may be composed from a superconducting material. A cold source may be desired to achieve a phase change to the state of superconductivity in the PV facility. Such a cold source can be supplied from the LAES apparatus in one or more ways as detailed above. One cold source may be liquid air directed from the liquid air generated during the charging cycle of the LAES apparatus. Another cold source may be an air stream byproduct that is generated during the charging cycle. Directing a cold source from the LAES may be performed during the LAES's different modes of operation i.e. charge cycle, discharge cycle, stand by (neither charging nor discharging).

According to one or more embodiments a LAES apparatus in conjunction with a coal power plant is revealed. Whereas the coal power plans contains at least one generator with said wires that may be from a superconducting material. Liquid air and/or liquid air components or gases air and/or gases air components at desired low temperatures may be directed to the superconducting wires in order to achieve a phase change thus operating during a superconductivity period. In order to achieve a phase change of the wires, the wires temperature can be reduced to a desired temperature.

Further, the coal power plant may have one or more transformers, whereas the one or more transformers may be of a superconducting material. In order to achieve a state of superconductivity the transformers can be reduced in temperature. Reduction of the temperature of the transformers may be achieved in a similar manner to that which has been detailed regarding the reduction of temperature of the wires. That is directing liquid air and/or liquid air components or gases air and/or gases air components at a desired temperature, which is generated from the LAES and/or ALU and/or ASU.

Reduction in the temperature of the wires and/or transformers may be achieved by directing at least one portion of the liquid air generated by the LAES to the wires and/or transformers.

Reduction in the temperature of the wires and/or transformers may be achieved by directing at least one portion of the liquid air generated by the ALU to the wires and/or transformers.

Reduction in the temperature of the wires and/or transformers may be achieved by directing at least one portion of at least one component of the liquid air components generated by the ASU to the wires and/or transformers.

Reduction in the temperature of the wires and/or transformers may be achieved by directing at least one portion of air and/or air component in a desired temperature to the wires and/or transformers from at least one of the LAES, ALU and/or ASU.

According to one or more embodiments a LAES apparatus in conjunction with a gas turbine is revealed. Whereas the gas plant may be a Simple Cycle Gas Turbine (SCGT) or a Combined Cycle Gas Turbine (CCGT) whereas the gas turbine contains at least one generator with said wires that may be from a superconducting material. Liquid air and/or liquid air components or gases air and/or gases air components at desired low temperatures may be directed to the superconducting wires in order to achieve a phase change thus operating during a superconductivity period. In order to achieve a phase change of the wires, the wires temperature can be reduced to a desired temperature.

Further, the gas turbine may have one or more transformers, whereas the one or more transformers may be of a superconducting material. In order to achieve a state of superconductivity the transformers can be reduced in temperature. Reduction of the temperature of the transformers may be achieved in a similar manner to that which has been detailed regarding the reduction of temperature of the wires. That is directing liquid air and/or liquid air components or gases air and/or gases air components at a desired temperature, which is generated from the LAES and/or ALU and/or ASU.

Reduction in the temperature of the wires and/or transformers may be achieved by directing at least one portion of the liquid air generated by the LAES to the wires and/or transformers.

Reduction in the temperature of the wires and/or transformers may be achieved be directing at least one portion of the liquid air generated by the ALU to the wires and/or transformers.

Reduction in the temperature of the wires and/or transformers may be achieved by directing at least one portion of at least one component of the liquid air components generated by the ASU to the wires and/or transformers.

Reduction in the temperature of the wires and/or transformers may be achieved by directing at least one portion of air and/or air component in a desired temperature to the wires and/or transformers from at least one of the LAES, ALU and/or ASU.

According to one or more embodiments a LAES apparatus in conjunction with one or more wind turbines. The one or more wind turbine may have wires connecting them to the grid, LAES or any other destination. Connecting the one or more wind turbines to the LAES may be desired in order to maintain a steady supply of power. That is during one period of time when the wind turbine/s are generating a sufficient amount of power the power could be placed directly on the grid. During a second period when the wind turbine/s are generating an excess of power a portion or all of the generated power may be stored in the LAES to be dispatched during a different period. And during a third period of time when the wind is generating a deficiency of power the LAES may be discharged thus offsetting the lack of generated power from the wind turbine/s, resulting in a steady (or relatively steady) supply of power from the system as a whole.

Thus, a facility could be configured with a large number of wind turbines. Whereas all (or a large portion) of the turbines may be connected through electrical wires to both the LAES and/or the electrical grid. As the number of turbine/s grow the amount of electrical wires connecting the turbine/s to the LAES and/or the grid (and/or other) grows. Thus it may be that the total amount of wires in such a facility would be large.

According to one or more embodiments of the disclosed matter, a facility is detailed containing a LAES an ALU and/or an ASU, and at least one wind turbine. Whereas the at least one wind turbine contains at least one electrical wire connecting the at least one wind turbine to the LAES and/or grid or both (or other consumer). According to the embodiment the wires connecting the at least one wind turbine may be of a superconductive material. Superconductive wire temperature can be reduced in order to achieve a phase change, and thus becoming a superconducting wire. A superconducting wire may suffer less loss of electricity that is passing through the wire. And/or allowing in the reduction of the size, diameter, width etc. of the desired wires.

According to one or more embodiments liquid air and/or liquid air component/s, and/or gases air and/or gases air component/s at desired temperature. Which has been generated from the LAES and/or the ALU and/or ASU is directed to the one or more wires of the one or more wind turbine/s. Whereas the temperature of the wires of the wind turbine/s are reduced to a desired temperature achieving a state of superconductivity.

Further, it may be case that the wind turbine/s may have generators containing wires which may be superconducting material and may be cooled down to reach a state of superconductivity as it has been detailed above. In addition, the wind turbine/s may have one or more transformers that may be of superconducting material and may be cooled down to reach a state of superconductivity as it has been detailed above.

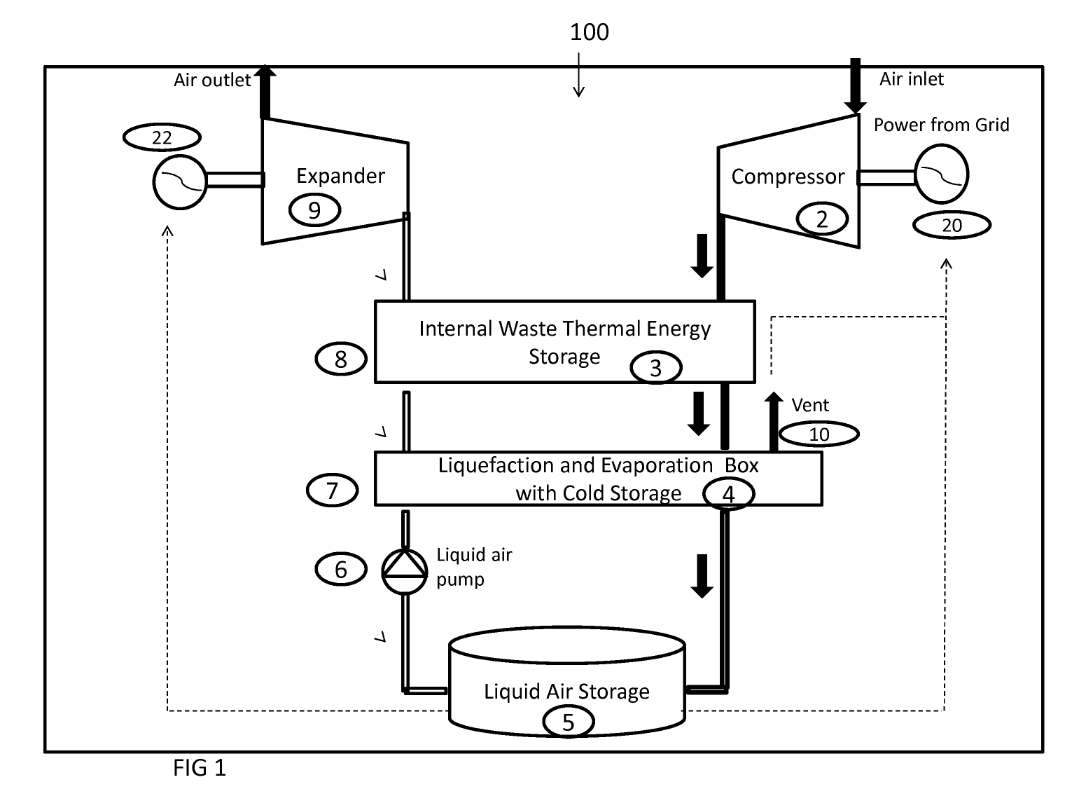

FIG. 1 illustrates a Liquid Air Energy Storage (LAES) apparatus 100 with superconducting devices, such as a motor (or motors) 20 and a generator (or generators) 22. LAES 100 may operate in a few modes of operation. In one mode of operation, LAES 100 may draw down electrical energy from any electrical source, convert the electrical energy to both high and low thermal energy temperatures, and generate a cryogen (i.e. liquid air) (this mode will be referred to as the charging cycle or mode). During a second period of time, LAES 100 may convert thermal energy stored in the LAES 100 to electrical energy that may be dispatched to the electrical grid.

During the LAES 100 charging mode, electrical energy may be drawn down from any electrical energy source to a power compressor 2 (or compressors indicated by compressor 2). The compressor 2 may trap air from the environment into the LAES 100. The compressed air temperature and pressure may rise as a result of the compression. High thermal energy may be extracted from the air and stored in an internal waste thermal energy storage 3. Thermal energy storage 3 may have one or more storage units. The air stream may be directed to further processing in order to achieve air liquefaction. A further process that may be performed to achieve liquefaction may include directing the air stream through cold storage units, further refrigeration devices (or apparatuses that resemble or operate as refrigeration), expansion of the air through a throttle device, or expansion turbine, etc. In some embodiments, apparatuses such as cold storage units, further refrigeration devices (or apparatuses that resemble or operate as refrigeration), throttle device, and/or expansion turbine, etc. may be located or associated with a Liquefaction and evaporation box with cold storage 4. The air stream exiting the Liquefaction and evaporation box with cold storage 4 may be liquefied. Liquid air may then be stored in a liquid air storage unit 5. A portion of the air stream may remain in a gaseous form; and, in some embodiments, the air stream which has remained in a gaseous form (byproduct) is directed through the Liquefaction and evaporation box with cold storage 4 to utilize the cold contained in the byproduct stream. The byproduct stream that has been redirected through the Liquefaction and evaporation box with cold storage 4 may be vented out 10 of the LAES 100 after exchanging thermal energy with the air stream that may be processed for liquefaction. However, the byproduct stream may be directed to a motor (or motors) 20 in order to achieve a state of superconductivity within the superconducting materials in the motor as will be detailed.

LAES apparatus 100 may also operate in a discharge mode. Liquid air pump 6 may pump liquid air from the liquid air storage unit 5, through the LAES apparatus 100 at a desired pressure. The liquid air may be processed in Liquefaction and evaporation box with cold storage 7 (where as the number change is indicative of the two modes of charge and discharge). During this process the liquid air stream may exchange thermal energy with concurrent air stream which is cooled down. The pumped air stream exits the Liquefaction and evaporation box with cold storage 7 and is directed to an internal waste thermal energy storage unit 8. In the internal waste thermal energy storage unit 8, the pumped liquid air stream (now in a gaseous form after evaporation) can further exchange thermal energy with the incoming air. During this process the air stream may exchange relatively low thermal energy temperature (relative to the thermal energy contained in the waste thermal energy storages units) with relatively high thermal energy contained in the substances of the internal waste thermal energy storage unit 8. In some embodiments, relatively low thermal energy that has been extracted from the liquid air may be stored in the waste thermal energy storage for use during the charging cycle. In some embodiments, the air stream exiting the internal waste thermal energy storage 8 may be directed to drive a turbine 9, which may generate electrical energy.

In some embodiments, LAES apparatus 100 may be assembled with one or more superconducting devices. Some of these devices may be a motor (or motors) indicated by motor 20 and/or generator (or generators) indicated by generator 22. The superconducting devices may have one or more components made from a superconducting material, such as, for example, superconducting wires. Superconducting wires may be places in the motors and/or generators. In some embodiments, the wires may be cooled down to achieve a state of superconductivity. The superconducting wires may be cooled down by directing a portion of the liquid air from liquid air storage 5 to the wires of all or some of the superconducting devices. One way in which directing liquid air to the wires may be achieved is by a liquid air pump (not shown in figure) which may pump the liquid air to the superconducting wires. In some embodiments, the liquid that has been directed to the wires may be cycled back to the liquid air storage 5 or the liquid air may be directed throughout the LAES apparatus 100 or vented out. In some embodiments, by achieving superconductivity in the wires, the superconducting devices may operate at higher efficiency.

In some embodiments, during the charging cycle, a portion of the air stream may remain in a gas form. This portion (byproduct) may be redirected back through LAES apparatus 100. In some embodiments, the byproduct may be directed to the motors 20 in order to achieve superconductivity. In some embodiments, the byproduct stream may be redirected back to the LAES apparatus 100 in order to cool down the air stream being processed in LAES apparatus 100. The byproduct may be vented out of the LAES apparatus 100, at different stages of the process.

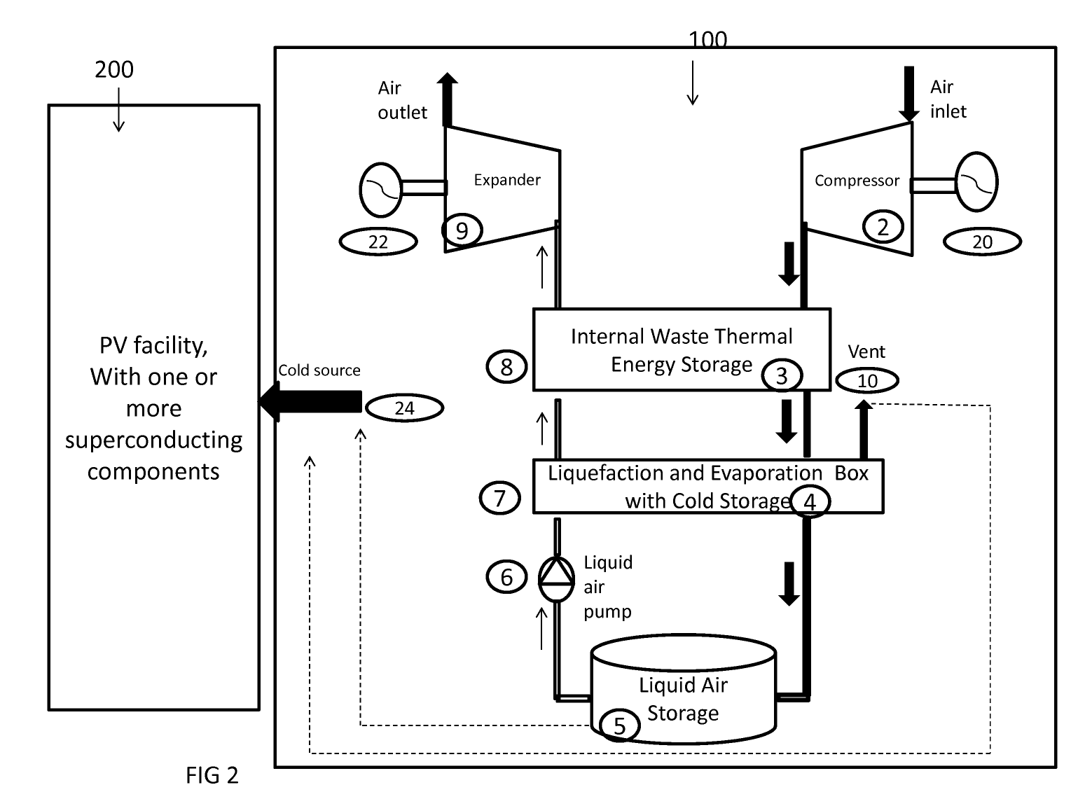

FIG. 2 illustrates a Liquid Air Energy Storage (LAES) apparatus 100 with superconducting devices, such as a motor 20 and a generator 22, in conjunction with a superconducting PV facility 200. In some embodiments, LAES 100 may operate as stated above. In some embodiments, PV facility 200 contains a plurality of PV modules, units and/or cells (not shown). One or more components within the PV facility 200 may be superconductors and one or more of the superconductors may be cooled down in order to achieve a state of superconductivity.

In some embodiments, LAES 100 provides a cold source 24 for the superconducting PV facility 200. In some embodiments, a portion of the liquid air stored to in the liquid air storage 5 may be directed toward the superconducting components of the PV facility 200. The liquid air that has been directed through the PV facility 200 may be redirected to liquid air storage 5 or may be redirected back to different process with in the LAES 100 or vented out. One way in which directing liquid air to the PV facility 200 may be achieved is by a liquid air pump (not shown) that pumps the liquid air to the superconducting components in the PV facility 200.

In some embodiments, during the charging cycle, a portion of the air stream may remain in a gas form. This portion (byproduct) may be redirected back through LAES apparatus 100. In some embodiments, the byproduct may be directed to PV facility 200 in order to achieve superconductivity. In some such embodiments, the byproduct stream may be redirected back to the LAES apparatus 100 in order to cool down the air stream being processed in LAES apparatus 100. The byproduct may be vented out of LAES apparatus 100, at different stages of the process.

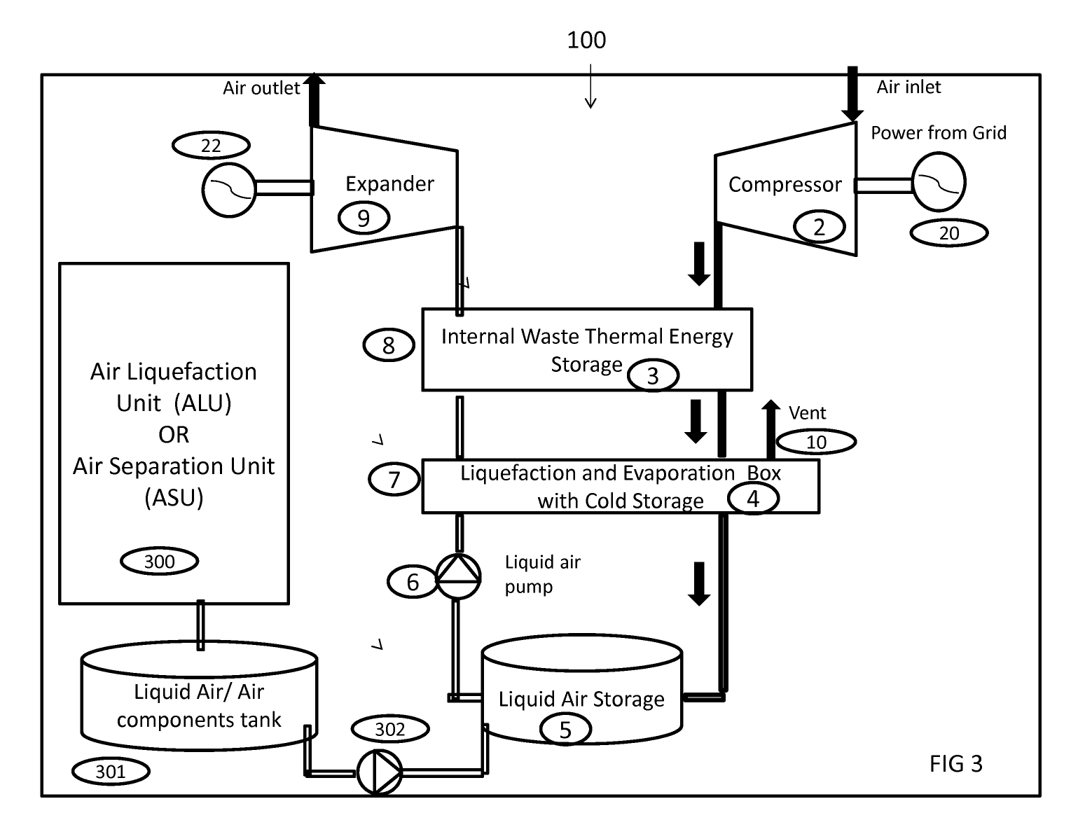

Referring to FIG. 3 a LAES operating in conjunction with an Air Liquefaction Unit (ALU) and or an Air Separation Unit (ASU) according to one embodiments. Whereas the LAES may operate as detailed above. In conjunction to the operations of the LAES, an ALU and/or ASU 300 is detailed. In the event that the LAES 100 is operating in conjunction to an ALU 300, the ALU 300 may generate liquid air. The generated liquid air may be transformed to the LAES through one or more suitable pipe/s and/or conduits. The liquid air may be directed to an intermediary Liquid Air Tank 301, whereas liquid air may be pumped from the intermediary Liquid Air Tank 301 via pump 302 to the LAES's Liquid Air Storage 5. The intermediary Liquid Air Tank 301 may not be desirable and the liquid air may flow directly (with or without a pump) to the LAES's Liquid Air Storage 5 (not shown in FIG. 3).

In the event that the LAES 100 is operating in conjunction to an ASU 300, the ASU 300 may generate one or more air components such as but not limited to Liquid nitrogen, liquid oxygen, liquid argon (and other components). One or more components may be transferred to the LAES's Liquid Air Storage 5, while one or more components may be designated for other uses (not shown in FIG. 3). One or more components will be directed to an intermediary Liquid Air Components Tank 301, whereas liquid air may be pumped from the intermediary Liquid Air components Tank 301 via pump 302 to the LAES's Liquid Air Storage 5. The intermediary Liquid Air component Tank 301 may not be desired and the liquid air one or more components may flow directly (with or without a pump) to the LAES's Liquid Air Storage 5 (not shown in FIG. 3).

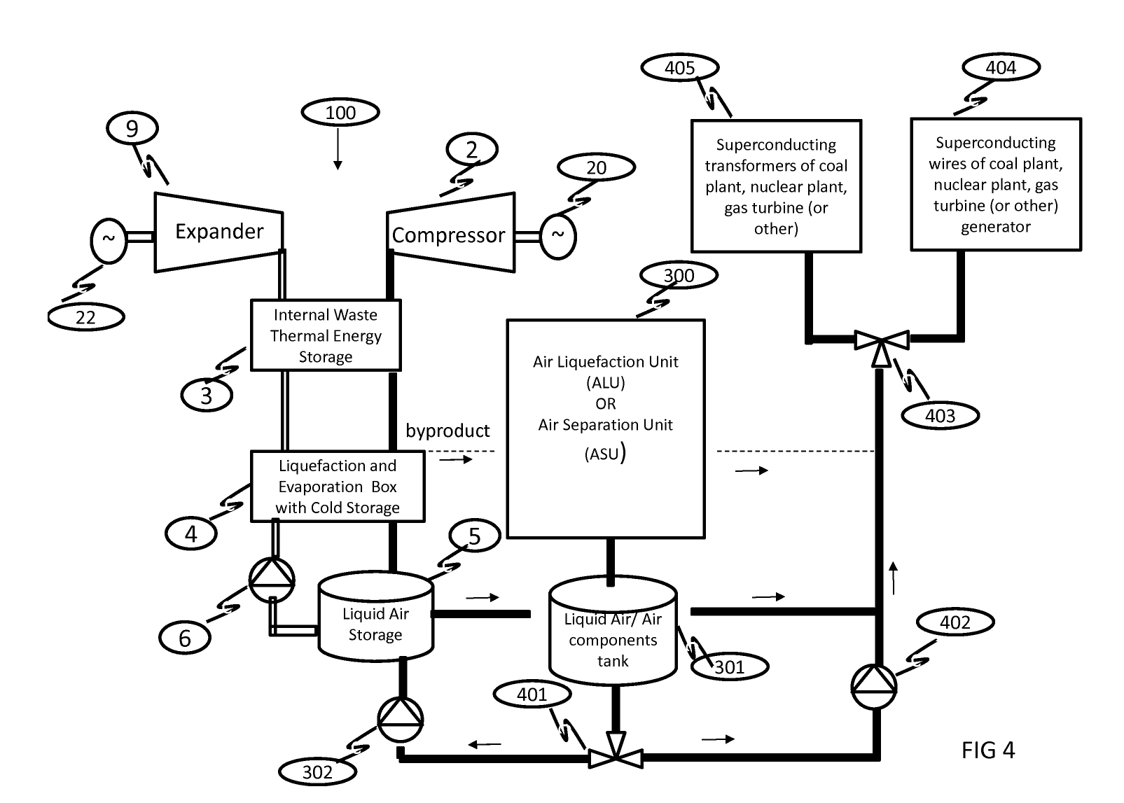

Referring to FIG. 4 a LAES apparatus 100 operating alongside an ALU and/or an ASU apparatus 300 is detailed, whereas both apparatuses are operating in conjunction to a coal power plant and/or a gas turbine. Whereas the LAES 100 and ALU and/or ASU 300 operate similarly to that which has been detailed.

In some embodiments, liquid air and/or liquid air components may be circulated from the LAES's Liquid Air Storage 5 and/or from the Liquid Air/Air Component Tank 301 to the wires of the generator of the stream or gas turbine of the coal plant or nuclear plant or gas turbine 404. In some such embodiments, the liquid air and/or liquid air components may be circulated from the LAES's Liquid Air Storage 5 and/or from the Liquid Air/Air Component Tank 301 to the one or more transformers of the coal plant and/or nuclear plant and/or gas turbine 405. In some embodiments, Liquid Air/Air Component Tank 301 is not used and the liquid air and/or liquid air components flow directly from the ALU and/or ASU 300 to the wires of the generator of the stream or gas turbine of the coal plant, nuclear plant or gas turbine 404 or the one or more transformers of the coal plant and/or nuclear plant and/or gas turbine 405. Circulating the liquid air and/or liquid air components may be achieved via pump illustrated as pump 402 in FIG. 4.

Control valves may be configured to control the flow of liquid air and/or liquid air components illustrated as controls 401 and 403 in FIG. 4 whereas there may be more or less controlled valves (not shown in FIG. 4).

Achieving the state of superconductivity of either the wires of the generator of the coal plant and/or the gas turbine and/or the one or more transformers, may be achieved by utilizing the byproduct stream generated from the LAES 100 and/or ALU and/or ASU 300, in addition to or separated of the liquid air and/or liquid air components. Wherein the thermal exchange from the liquid air and/or liquid air components and/or desires temperature air in a gas form and/or air components in a gas form, with the wires of the generator of the coal plant and/or the gas turbine and/or the one or more transformers may be achieved by at least one of a direct or non-direct heat exchange method.

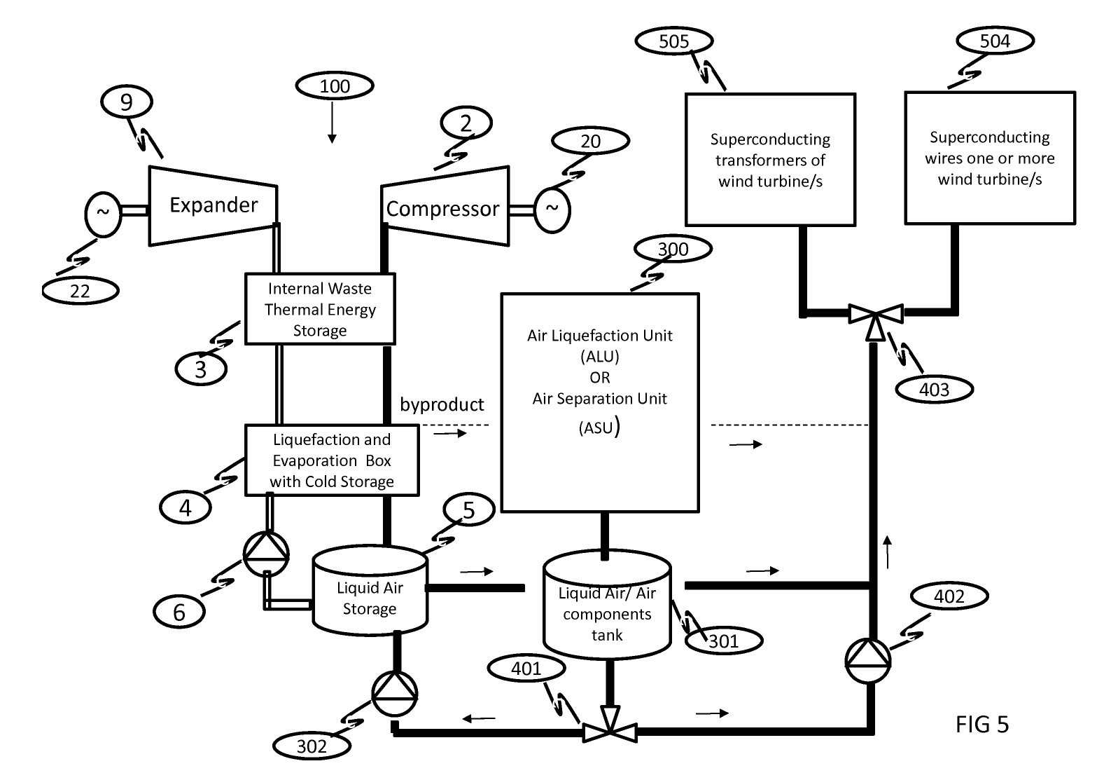

Referring to FIG. 5 a LAES apparatus 100 operating alongside an ALU and/or an ASU apparatus 300 is detailed, whereas both apparatuses are operating in conjunction to a coal power plant and/or a gas turbine. Whereas the LAES 100 and ALU and/or ASU 300 operate similarly to that which has been detailed.

It may be that liquid air and/or liquid air components may be circulated from the LAES's Liquid Air Storage 5 and/or from the Liquid Air/Air Component Tank 301 to the wires of the one or more wind turbine/s 504. Whereas generated electricity by the one or more wind turbine/s may be directed to the LAES, grid or any other designation. Wherein the wires may be over ground and/or underground. The liquid air and/or liquid air components may be circulated from the LAES's Liquid Air Storage 5 and/or from the Liquid Air/Air Component Tank 301 to the one or more transformers of the one or more wind turbine/s 505. The Liquid Air/Air Component Tank 301 may not be desired and the liquid air and/or liquid air components will flow directly from the ALU and/or ASU 300 to the wires of the one or more wind turbine/s 504 or the one or more transformers of wind turbine/s 505. Circulating the liquid air and/or liquid air components may be achieved via pump illustrated as pump 402 in FIG. 5.

Control valves may be configured to control the flow of liquid air and/or liquid air components illustrated as controls 401 and 403 in FIG. 5 whereas there may be more or less controlled valves (not shown in FIG. 5).

Achieving the state of super conductivity of either the wires of the one or more wind turbine/s and/or the one or more transformers, may be achieved by utilizing the byproduct stream generated from the LAES 100 and/or ALU and/or ASU 300, in addition to or separated of the liquid air and/or liquid air components. Wherein the thermal exchange from the liquid air and/or liquid air components and/or desires temperature air in a gas form and/or air components in a gas form, with the wires of the generator of the coal plant and/or the gas turbine and/or the one or more transformers may be achieved by at least one of a direct or non-direct heat exchange method.

It will be appreciated that the modules, processes, systems, and sections described above can be implemented in hardware, hardware programmed by software, software instruction stored on a non-transitory computer readable medium or a combination of the above. For example, a method for controlling energy systems can be implemented, for example, using a processor configured to execute a sequence of programmed instructions stored on a non-transitory computer readable medium. For example, the processor can include, but not be limited to, a personal computer or workstation or other such computing system that includes a processor, microprocessor, microcontroller device, or is comprised of control logic including integrated circuits such as, for example, an Application Specific Integrated Circuit (ASIC). The instructions can be compiled from source code instructions provided in accordance with a programming language such as Java, C++, C#.net or the like. The instructions can also comprise code and data objects provided in accordance with, for example, the Visual Basic™ language, LabVIEW, or another structured or object-oriented programming language. The sequence of programmed instructions and data associated therewith can be stored in a non-transitory computer-readable medium such as a computer memory or storage device which may be any suitable memory apparatus, such as, but not limited to read-only memory (ROM), programmable read-only memory (PROM), electrically erasable programmable read-only memory (EEPROM), random-access memory (RAM), flash memory, disk drive and the like.

Furthermore, the modules, processes, systems, and sections can be implemented as a single processor or as a distributed processor. Further, it should be appreciated that the steps mentioned above may be performed on a single or distributed processor (single and/or multi-core). Also, the processes, modules, and sub-modules described in the various figures of and for embodiments above may be distributed across multiple computers or systems or may be co-located in a single processor or system. Exemplary structural embodiment alternatives suitable for implementing the modules, sections, systems, means, or processes described herein are provided below.

The modules, processors or systems described above can be implemented as a programmed general purpose computer, an electronic device programmed with microcode, a hard-wired analog logic circuit, software stored on a computer-readable medium or signal, an optical computing device, a networked system of electronic and/or optical devices, a special purpose computing device, an integrated circuit device, a semiconductor chip, and a software module or object stored on a computer-readable medium or signal, for example.

Embodiments of the method and system (or their sub-components or modules), may be implemented on a general-purpose computer, a special-purpose computer, a programmed microprocessor or microcontroller and peripheral integrated circuit element, an ASIC or other integrated circuit, a digital signal processor, a hardwired electronic or logic circuit such as a discrete element circuit, a programmed logic circuit such as a programmable logic device (PLD), programmable logic array (PLA), field-programmable gate array (FPGA), programmable array logic (PAL) device, or the like. In general, any process capable of implementing the functions or steps described herein can be used to implement embodiments of the method, system, or a computer program product (software program stored on a non-transitory computer readable medium).

Furthermore, embodiments of the disclosed method, system, and computer program product may be readily implemented, fully or partially, in software using, for example, object or object-oriented software development environments that provide portable source code that can be used on a variety of computer platforms. Alternatively, embodiments of the disclosed method, system, and computer program product can be implemented partially or fully in hardware using, for example, standard logic circuits or a very-large-scale integration (VLSI) design. Other hardware or software can be used to implement embodiments depending on the speed and/or efficiency requirements of the systems, the particular function, and/or particular software or hardware system, microprocessor, or microcomputer being utilized. Embodiments of the method, system, and computer program product can be implemented in hardware and/or software using any known or later developed systems or structures, devices and/or software by those of ordinary skill in the applicable art from the function description provided herein and with a general basic knowledge of energy processing and storage and/or computer programming arts.

Moreover, embodiments of the disclosed method, system, and computer program product can be implemented in software executed on a programmed general purpose computer, a special purpose computer, a microprocessor, or the like.

It is, thus, apparent that there is provided, in accordance with the present disclosure, LAES Operating Phase Change Materials. Many alternatives, modifications, and variations are enabled by the present disclosure. Features of the disclosed embodiments can be combined, rearranged, omitted, etc., within the scope of the invention to produce additional embodiments. Furthermore, certain features may sometimes be used to advantage without a corresponding use of other features. Accordingly, Applicants intend to embrace all such alternatives, modifications, equivalents, and variations that are within the spirit and scope of the present invention.

1-21. (canceled)

22. A Liquid Air Energy Storage apparatus comprising:
first components including:
a motor adapted to compress a working fluid,
a generator adapted to produce electric energy, and
a transformer adapted to convert electric energy; and
a liquid air storage unit,
wherein at least one of the first components comprises a superconductive material.

23. The apparatus of claim 22, wherein the least one of the first components comprising the superconductive material comprises wire of the superconductive material that reaches a state of superconductivity by diverting a cryogen to the wire.

24. The apparatus of claim 23,
wherein the diverted cryogen undergoes a phase change, and
wherein a gas product of the cryogen is diverted to a liquefaction and evaporation unit adapted to utilize gas cold thermal energy and perform further processing for a cryogen production.

25. The apparatus of claim 22,
wherein the motor comprises wire of a superconductive material that reaches a state of superconductivity by diverting a cryogen to the wire,
wherein the diverted cryogen undergoes a phase change, and
wherein a gas product of the cryogen is diverted to a liquefaction and evaporation unit adapted to utilize gas cold thermal energy and perform further processing for a cryogen production.

26. The apparatus of claim 22,
wherein the generator comprises wire of a superconductive material that reaches a state of superconductivity by diverting a cryogen from a cryogen storage unit to the wire,
wherein the diverted cryogen undergoes a phase change, and
wherein a gas product of the cryogen is diverted to a liquefaction and evaporation unit adapted to utilize gas cold thermal energy and perform further processing for a cryogen production.

27. The apparatus of claim 22,
wherein the transformer comprises wire of a superconductive material that reaches a state of superconductivity by diverting a cryogen from a cryogen storage unit to the wire,
wherein the diverted cryogen undergoes a phase change, and
wherein a gas product of the cryogen is diverted to a liquefaction and evaporation unit adapted to utilize gas cold thermal energy and perform further processing for a cryogen production.

28. The apparatus of claim 22, wherein the first components further includes a solar photovoltaic electrical energy production facility

29. The apparatus of claim 28,
wherein the solar photovoltaic electrical energy production facility comprises a component comprising wire of a superconductive material that reaches a state of superconductivity by diverting a cryogen from a cryogen storage unit to the wire
wherein the diverted cryogen undergoes a phase change, and
wherein a gas product of the cryogen is diverted to a liquefaction and evaporation unit adapted to utilize gas cold thermal energy and perform further processing for a cryogen production.

30. A system comprising:
a first unit being a Liquid Air Energy Storage unit (LAES);
a second unit being an Air Separation Unit (ASU) or an Air Liquefaction Unit (ALU);
a third unit being a coal power plant, a gas turbine, a PV field, or a wind turbine;
the third unit comprising at least one component that is a superconductor; and
a controller to configure the system to cool the superconductor component to a desired low temperature such that a state of superconductivity is reachable by the superconductor component, the cooling the superconductor component including passing material generated by the first and/or second units to the third unit to achieve the desired low temperature of the superconductor component,
wherein the material is at least one of liquid air, liquid air components, desired temperature air in a gas form, and/or air components in a gas form.

31. The system of claim 30,
wherein the third unit comprises a generator comprising wires of a superconductive material, the wires being the superconductor component; and
wherein the cooling includes thermal energy transfer that is one of direct or non-direct heat exchange.

32. The system of claim 30,
wherein the third unit comprises a transformer comprising a device comprising a superconductive material, the device being the superconductor component; and
wherein the cooling includes thermal energy transfer that is one of direct or non-direct heat exchange.

33. The system of claim 31, wherein the third unit is a coal power plant.

34. The system of claim 31, wherein the third unit is a nuclear power plant.

35. The system of claim 31, wherein the third unit is a gas turbine.

36-40. (canceled)

41. The system of claim 30,
wherein the third unit is a wind turbine;
wherein the wind turbine comprises a wire transmitting electricity from the wind turbine to at least one recipient, the wire being of a superconductive material, the wires being the superconductor component; and
wherein the cooling includes thermal energy transfer that is one of direct or non-direct heat exchange.

42. The system of claim 30, wherein the material, after reducing the temperature of the superconductor component, is vented to the environment and/or recirculated to the first and/or second units.

43. A method for cooling superconductive components of an energy system, the method comprising:
providing a system comprising:
a first unit being a Liquid Air Energy Storage unit (LAES),
a second unit being an Air Separation Unit (ASU) or an Air Liquefaction Unit (ALU),
a third unit being a coal power plant, a gas turbine, a PV field, or a wind turbine,
the third unit comprising at least one component that is a superconductor; and
cooling the superconductor component to a desired low temperature such that a state of superconductivity is reachable by the superconductor component, the cooling comprising passing material generated by the first and/or second units to the third unit to achieve the desired low temperature of the superconductor component,
wherein the material is at least one of liquid air, liquid air components, desired temperature air in a gas form, and/or air components in a gas form.

44. The method of claim 43,
wherein the third unit comprises a generator comprising wires of a superconductive material, the wires being the superconductor component; and
wherein the cooling includes thermal energy transfer that is one of direct or non-direct heat exchange.

45. The method of claim 43,
wherein the third unit comprises a transformer comprising a device comprising a superconductive material, the device being the superconductor component; and
wherein the cooling includes thermal energy transfer that is one of direct or non-direct heat exchange.

46-54. (canceled)

55. The method of claim 43, further comprising:
after reducing the temperature of the superconductor component, venting the material to the environment and/or recirculating the material to the first and/or second units.
